(19) United States
(12) Patent Application Publication
(10) Pub. No.: US 2023/0311873 A1
(43) Pub. Date: Oct. 5, 2023

(54) METHOD, SYSTEM, AND APPARATUS OF A TETHERED AUTONOMOUS TRAILER WITH SMART HITCH

(71) Applicant: GM GLOBAL TECHNOLOGY OPERATIONS LLC, Detroit, MI (US)

(72) Inventors: Michael Ray Bolf, Warren, MI (US); Brian V. Castillo, Birmingham, MI (US); Justin M Wade, South Lyon, MI (US); Christopher Alexander O'Brien, Royal Oak, MI (US)

(73) Assignee: GM GLOBAL TECHNOLOGY OPERATIONS LLC, Detroit, MI (US)

(21) Appl. No.: 17/657,740

(22) Filed: Apr. 1, 2022

(51) Int. Cl. B60W 30/16; B60W 60/00; B62D 59/04; B60D 1/62; B60W 10/20; B60W 10/08

(52) U.S. Cl. CPC B60W 30/16; B60W 60/001; B62D 59/04; B60D 1/62; B60W 10/20; B60W 10/08; B60W 2300/14; B60W 2710/081; B60W 2710/20; B60W 2720/10; B60W 2530/207; B60W 2520/22

(57) ABSTRACT

Methods, systems, and apparatuses are provided for a vehicle tethered by a hitch to a trailer. The method includes generating sensor data from one or more sensors that are responsive to forces applied to the hitch by a vehicle mechanically coupled to the hitch; receiving sensor data to compute a direction for the guidance of the trailer; monitoring a set of parameters reflecting forces in a lateral and traverse direction derived from data generated by the sensors wherein the set of parameters include at least one parameter of a magnitude of force, and at least one parameter of the direction of force acting upon the hitch; and calculating at least a rate-of-change of the magnitude of force and direction over time to determine a trajectory for the trailer that enables the trailer to follow the lead vehicle without a tractive effort of the lead vehicle.

### INTRODUCTION

The technical field generally relates to trailers and vehicles, and, more specifically, to methods, systems, and apparatuses for controlling a self-propelled trailer tethered to a lead vehicle from forces applied to a smart hitch caused by movement of the lead vehicle while connected to the trailer via the smart hitch which is sensed by force sensors integrated with the smart hitch to enable tracking of the trailer with the lead vehicle.

Certain vehicles today are equipped to tow a trailer during travel by coupling the vehicle to a trailer to perform a towing operation. With conventional trailers, the towing operation is dependent on the towing capabilities of the vehicle and the weight of the trailer and its load not exceeding the capacity of the vehicle to perform the towing operation. As a result, the ability to tow a conventional trailer by a vehicle is dependent on the tractive capability (i.e., pulling power or drawing capacity) of the towing vehicle where the greater the tractive capability of the towing vehicle, the greater the towing capacity (i.e., the trailer and load) realized.

Accordingly, it is desirable to provide methods, systems, and apparatuses for towing a trailer that obviates the capacity constraints of the towing vehicle. Furthermore, other desirable features and characteristics of the present invention will become apparent from the subsequent detailed description of the invention and the appended claims, taken in conjunction with the accompanying drawings and this background of the invention.

### SUMMARY

In accordance with an exemplary embodiment, a method is provided that includes: generating, by a hitch in communication with a trailer, sensor data from one or more sensors that is responsive to one or more forces applied to the hitch wherein the one or more forces are provided by a lead vehicle mechanically coupled to the hitch; receiving, by a controller disposed within the trailer the sensor data generated by the one or more sensors of the hitch to compute a direction for the guidance of the trailer wherein the trailer is configured as a self-propelled trailer; monitoring, by the controller, a set of parameters reflecting one or more forces in a lateral and traverse direction derived from data generated by the one or more sensors of the hitch wherein the set of parameters include at least one parameter of a magnitude of force, and at least one parameter of the direction of force acting upon the hitch; calculating, by the controller, a rate-of-change of the magnitude of force and direction of force over time, and a cumulative integral over time of the magnitude of force and direction of force applied to the hitch, a rate-of-change of a force direction and magnitude, and an integral force direction and magnitude that are based on time-stamped data from the one or more sensors; and calculating, by the controller, based on the set of variables that have been determined, a trajectory for the self-propelled trailer that enables the self-propelled trailer to follow the lead vehicle without depending upon a tractive effort of the lead vehicle.

In an embodiment, the method includes outputting, by the controller, the trajectory that is calculated to a steering controller and a motor speed controller, which enables physical control of motion of the self-propelled trailer.

In an embodiment, the method includes configuring the hitch to communicate with the controller to enable receipt of data from one or more sensors so that the self-propelled trailer and the hitch can be guided manually or by the lead vehicle.

In an embodiment, one or more sensors include the first set of sensors that monitor forces imposed upon the hitch in a transverse direction and the second set of sensors that monitors forces imposed upon the hitch in a longitudinal direction.

In an embodiment, the hitch includes a first joint enabling rotation about a transverse axis and located at the coupling about which the hitch is affixed to the lead vehicle, and a second joint enabling rotation about a vertical axis and located at the coupling about which the hitch is affixed to the lead vehicle.

In an embodiment, the hitch further includes a third joint enabling rotation about a longitudinal axis and located on a trailer beam that extends rearward from the coupling, and a fourth joint enabling rotation about the transverse axis and located at a connection between a rear part of the trailer beam and a trailer body or chassis of the trailer.

In an embodiment, the method further includes adjusting, by the steering controller, a direction of a steering angle of a set of wheels of the trailer based on calculations from the force direction, rate-of-change of direction, and integral of force direction.

In an embodiment, the method further includes adjusting, by the motor speed controller, a set speed of the trailer based on calculations from the magnitude of the force, rate-of-change of force magnitude, and time-integral of force magnitude so as to minimize the magnitude of force experienced at the hitch.

In an embodiment, the method further includes adjusting, by the motor speed controller, by an incremental change the set speed of the trailer based on a previous set speed value to minimize the at least one magnitude of force experienced at the hitch.

In another embodiment, a system is provided. The system includes one or more sensors disposed in a hitch to provide sensor data onboard a trailer that is coupled to a lead vehicle; and a processor configured to be coupled to the one or more sensors while onboard the trailer and configured to: obtain sensor data from the one or more sensors configured within the hitch that is attached to the trailer; receive the sensor data generated by the one or more sensors of the hitch to compute a direction for guidance of the trailer wherein the trailer is configured as a self-propelled trailer; monitor a set of parameters that reflect one or more forces in a lateral and traverse direction derived from data generated by the one or more sensors of the hitch wherein the set of parameters include at least one parameter of a magnitude of the force and at least one parameter of the direction of force acting upon the hitch; calculate a rate-of-change of the magnitude of force and direction of force over time, and a cumulative integral over time of the magnitude of force and direction of force applied to the hitch, a rate-of-change of a force direction and magnitude, and an integral force direction and magnitude that are based on time-stamped data from the one or more sensors; and calculate, based on the set of variables that have been determined, a trajectory for the self-propelled trailer that enables the self-propelled trailer to follow the lead vehicle without depending upon a tractive effort of the lead vehicle.

In an embodiment, the processor is configured to: output the trajectory that is calculated to enable physical control of motion of the self-propelled trailer.

In an embodiment, the processor is configured to: receive the sensor data to compute directional data to guide the self-propelled trailer while coupled to the vehicle without necessitating the vehicle to provide motive force to the self-propelled trailer.

In an embodiment, the processor is configured to: communicate with the hitch to enable receipt of data from one or more sensors so that the self-propelled trailer and the hitch can be guided manually or by the lead vehicle.

In an embodiment, the hitch includes a first joint enabling rotation about a transverse axis and located at the coupling about which the hitch is affixed to the lead vehicle, and a second joint enabling rotation about a vertical axis and located at the coupling about which the hitch is affixed to the lead vehicle.

In an embodiment, the hitch further includes a third joint enabling rotation about a longitudinal axis and located on a trailer beam that extends rearward from the coupling, and a fourth joint enabling rotation about the transverse axis and located at a connection between a rear part of the trailer beam and a trailer body or chassis of the trailer.

In an embodiment, the processor is configured to adjust a direction of a steering angle of a set of wheels of the trailer based on calculations from the force direction, rate-of-change of direction, and integral of force direction.

In an embodiment, the processor is configured to adjust a set speed of the trailer based on calculations from the magnitude of force, rate-of-change of force magnitude, and time-integral of force magnitude so as to minimize the magnitude of force experienced at the hitch.

In an embodiment, the processor is configured to adjust by an incremental change the set speed of the trailer based on a previous set speed value to minimize at least one magnitude of force experienced at the hitch.

In yet another embodiment, an apparatus is provided. The apparatus includes a hitch including a mechanical coupling between a trailer and a vehicle; and a communication connection to enable sending of sensor data provided by the hitch to a processor device remote from the hitch; wherein the hitch is configured with one or more sensors that generate the sensor data sent to the processor device wherein the sensor data is generated in response to one or more forces applied by the vehicle via the mechanical coupling of the hitch; wherein the processor device is disposed remotely in the trailer and enables control of a trajectory of the trailer while operating via the communication connection to the vehicle wherein the processor device is configured to: obtain the sensor data from the one or more sensors configured within the hitch that is attached to the trailer; receive the sensor data generated by the one or more sensors of the hitch to compute a direction for guidance of the trailer wherein the trailer is configured as a self-propelled trailer; monitor a set of parameters that reflect one or more forces in a lateral and traverse direction derived from data generated by the one or more sensors of the hitch wherein the set of parameters include at least one parameter of a magnitude of the force and at least one parameter of direction of force acting upon the hitch; calculate a rate-of-change of the magnitude of force and direction of force over time, and a cumulative integral over time of the magnitude of force and direction of force applied to the hitch, a rate-of-change of a force direction and magnitude, and an integral force direction and magnitude that are based on time-stamped data from the one or more sensors; and calculate, based on the set of variables that have been determined, the trajectory for the self-propelled trailer that enables the self-propelled trailer to follow the vehicle without depending upon a tractive effort of the vehicle.

In an embodiment, the mechanical coupling is configured with a set of joints that allow for motion about a transverse Y-axis, a longitudinal X-axis, and a Z-axis of a frame of the mechanical coupling and is responsive to the one or more forces applied by the vehicle.

### DESCRIPTION OF THE DRAWINGS

The present disclosure will hereinafter be described in conjunction with the following drawing figures, wherein like numerals denote like elements, and wherein:

FIG. 1 is a functional block diagram of a trailer/hitch/vehicle system that includes a trailer tracking and operating in concert with a lead vehicle during travel, and in which a control system independently controls the trailer based on forces applied to the smart hitch by the lead vehicle when tethered to the trailer, in accordance with exemplary embodiments;

FIGS. 2A, 2B, 2C, and 2D are diagrams of aspects of the smart hitch and the trailer to enable the control of the trailer based on forces applied to the smart hitch by the lead vehicle when tethered to the trailer in accordance with exemplary embodiments; and

FIG. 3 is a flow diagram of certain steps in the operation of the aspects of diagrams of 2A, 2B, 2C, and 2D, including determining a steering angle and speed of the trailer while tethered to the lead vehicle based on forces applied to the smart hitch by the lead vehicle in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

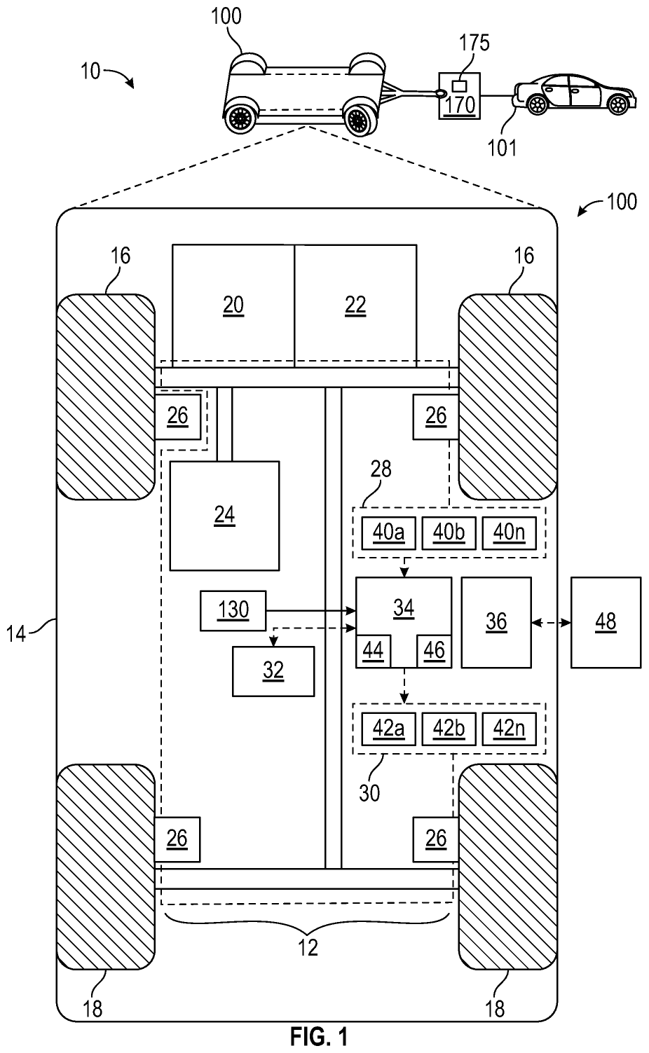

FIG. 1 illustrates a diagram of a travel system 10 having a towing vehicle 101 and a trailer 100 configured in accordance with various embodiments. In various embodiments, the trailer 100 couples to the vehicle 101 via a connection apparatus 170, which is configured to guide and/or tow the trailer 100. In certain embodiments, the connection apparatus 170 includes a force-sensing hitch 175, the force sensing hitch 175 can be configured with functionalities that include biaxial force sensing capabilities that enable the force sensing hitch 175 to sense at least the direction and magnitude of forces applied by the lead vehicle 101 while trailer 100 is tethered to the lead vehicle 101 via the force sensing hitch 175. Based on the sensed forced data received by trailer 100, trailer 100 is configured to follow the trajectory of the lead vehicle 101 while tethered to the lead vehicle 101. The force-sensing hitch 175 provides sufficient real-time data to enable the trailer 100 to operate independently or semi-independently (to track the lead vehicle 101 while tethered only) without requiring any inputs or electronic connections (e.g., a standard 7 pin connector or the like used in controlling trailer brakes, signals, coupling of auxiliary power, and ground connections) between trailer 100 and the lead vehicle 101.

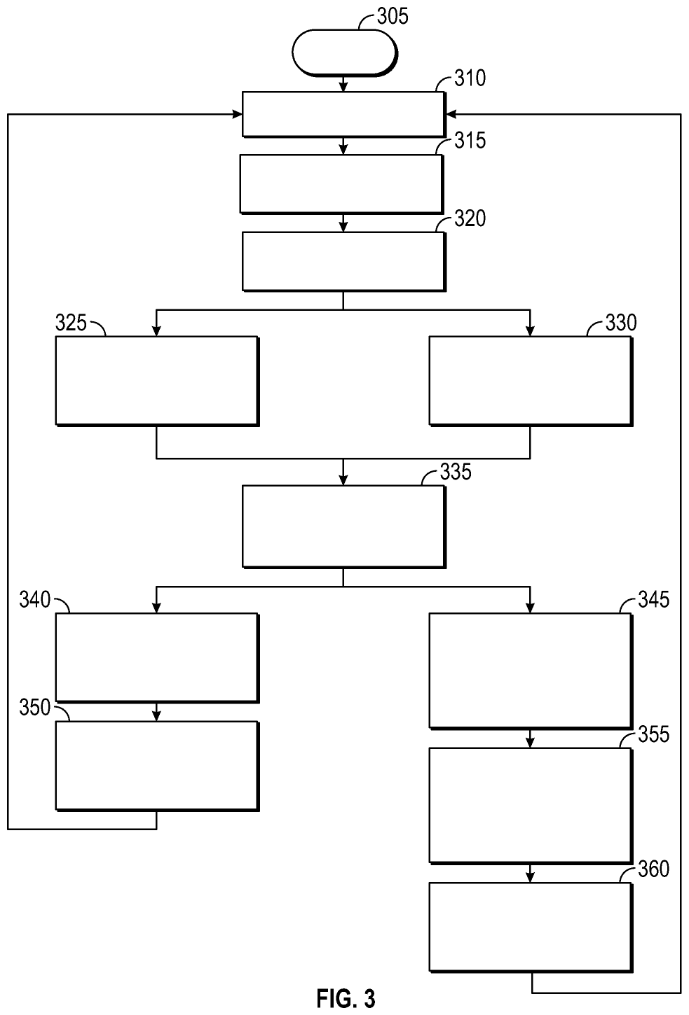

In embodiments, the trailer 100 is configured as a self-propelled vehicular type of trailer that may include features of propulsion and steering systems that can power the trailer 100 to move without requiring motive force from lead vehicle 101 and can be guided solely by data provided by the force sensing hitch 175. In embodiments, the trailer controller is configured to include a tracking algorithm (described in FIGS. 3 and 4) that receives force input data generated by one or more force sensors integrated into the force-sensing hitch 175 which enables directional and speed commands to control the trailer 100 in concert with the tethered lead vehicle 101. In embodiments, the independent powered operation of the trailer 100 provides for enhanced or larger towing capacities for the lead vehicle 101 than those consistent with conventional towing, as specified in SAE J2807 towing standards (i.e., a towing standard that covers suspension, steering, braking capacity, engine power, tire size and other metrics of the vehicle engaged in towing actions). In implementations, the requirements customarily put forth describing tractive capability for performing the towing operation of the tethered trailer 100 by the lead vehicle 101 are not of relevance or are of little relevance because of the independence of powered operation of the tethered trailer 100.

In embodiments, the independent powered operation of the tethered trailer 100 enables reduced tractive efforts required on the part of the towing vehicle 101, as the towing vehicle 101 is simply required to provide route guidance to the tethered trailer 100. Also, by having a tethered connection with the lead vehicle 101, the risk of uncontrolled or unconstrained operation is reduced as trailer 100 is always coupled and constrained to actions and movement of the lead vehicle 101. In embodiments, a trailer 100 movement in a reverse direction or when performing a hitching action to the lead vehicle 101 is made easier or more convenient because less force is required to move the trailer 100 in a reverse direction, and only a mechanical coupling is required (at a minimum) for the tethering of the lead vehicle 101 to the trailer 100. The force sensing hitch 175 provides a non-complex mechanical tethering that is configurable with trailer hitches and receptacles.

As described in greater detail further below, trailer 100 includes a trailer controller 34 for controlling operation and movement of the trailer 100 in concert with the sensing hitch 175 and the vehicle 101 (i.e., the entire travel system 10) where the sensing hitch 175 provides sensed data used to guide the trailer 100 during travel while tethered to the vehicle 101 in accordance with an exemplary embodiment.

In various embodiments, the trailer 100 includes functionalities similar to those contained in an autonomous vehicle or a semi-autonomous vehicle with capabilities to independently carry a load in accordance with specifications of the trailer 100 or with the assistance of force applied by the vehicle 101 via the connection apparatus 170 tethering (i.e., coupling or linking) the trailer 100 to the lead vehicle 101.

The trailer 100 may be any one of a number of different types of trailers, such as, for example, a wagon, a truck trailer, agricultural/industrial vehicle, or a camping vehicle, and may be two-wheel-drive (2WD) (i.e., rear-wheel drive or front-wheel drive), four-wheel drive (4WD) or all-wheel drive (AWD), and/or various other types of vehicles in certain embodiments.

The trailer 100 may include a body 14 (or a flatbed) that is arranged on a chassis 12. The body 14 substantially encloses other components of the trailer 100. The body 14 and chassis 12 may jointly form a frame to which the sensing hitch 175 is attached. The trailer 100 may also include a plurality of wheels 16, 18. The wheels 16, 18 are each rotationally coupled to the chassis 12 near a respective corner of the body 14 (or segmented in pairs at locations across the chassis to support the load carried) to facilitate movement of the trailer 100 with or without a carried load. In one embodiment, the trailer 100 includes four wheels (16,18) although this may vary in other embodiments (for example for truck trailers and certain other longer or shorter trailers).

As shown, trailer 100 generally includes a propulsion system 20, a transmission system 22, a steering system 24, a braking system 26, a sensor system 28, an actuator system 30, at least one data storage device 32, at least one controller 34, and a communication system 36 to a remote server 48 for receiving software updates (e.g., adaptive model updates), and control data. The propulsion system 20 may, in this example, include an electric machine such as a permanent magnet (PM) motor. The transmission system 22 is configured to transmit power from the propulsion system 20 to the vehicle wheels 16 and 18 via one or more selectable speed ratios.

The sensor system 28 includes one or more sensing devices 40a-40n used in controlling the operating state of the trailer 100 (such as the steering angle) and generating sensor data relating thereto. The actuator system 30 includes one or more actuator devices 42a-42n that control one or more vehicle features such as, but not limited to, the propulsion system 20, the transmission system 22, the steering system 24, and the braking system 26. In various exemplary embodiments, trailer 100 may also include interior and/or exterior trailer features not illustrated in FIG. 1, such as various doors, enclosures, touch-screen display components, and the like.

The data storage device 32 stores data for use in controlling the vehicle 101. The data storage device 32 may be part of controller 34, separate from controller 34, or part of controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an application-specific integrated circuit (ASIC) (e.g., a custom ASIC implementing a neural network), a field-programmable gate array (FPGA), an auxiliary processor among several processors associated with the controller 34, a semiconductor-based microprocessor (in the form of a microchip or chipset), any combination thereof, or generally any device for executing instructions. The computer-readable storage device or media 46 may include volatile and non-volatile storage in read-only memory (ROM), random-access memory (RAM), and keep-alive memory (KAM), for example. KAM is a persistent or non-volatile memory used to store various operating variables while processor 44 is powered down. The computer-readable storage device or media 46 may be implemented using any of several known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the trailer 100.

The instructions may include one or more separate programs, each of which includes an ordered listing of executable instructions for implementing logical functions. The instructions, when executed by the processor 44, receive and process signals (e.g., sensor data) from the sensor system 28, perform logic, calculations, methods, and/or algorithms for automatically controlling the components of the trailer 100, and generate control signals that are transmitted to the actuator system 30 to automatically control the components of the trailer 100 based on the logic, calculations, methods, and/or algorithms. Although only one controller 34 is shown in FIG. 1, embodiments of the trailer 100 may include any number of controllers 34 that communicate over any suitable communication medium or a combination of communication mediums and that cooperate to process the sensor signals, perform logic, calculations, methods, and/or algorithms, and generate control signals to automatically control features of the trailer 100.

For example, the controller 34 may include any number of additional sub-modules embedded within, which may be combined and/or further partitioned to similarly implement systems and methods described herein. Additionally, inputs to the trailer 100 may be received from the sensor system 28, received from other control modules (not shown) associated with the trailer 100, and/or determined/modeled by other sub-modules (not shown) within the controller 34 of FIG. 1.

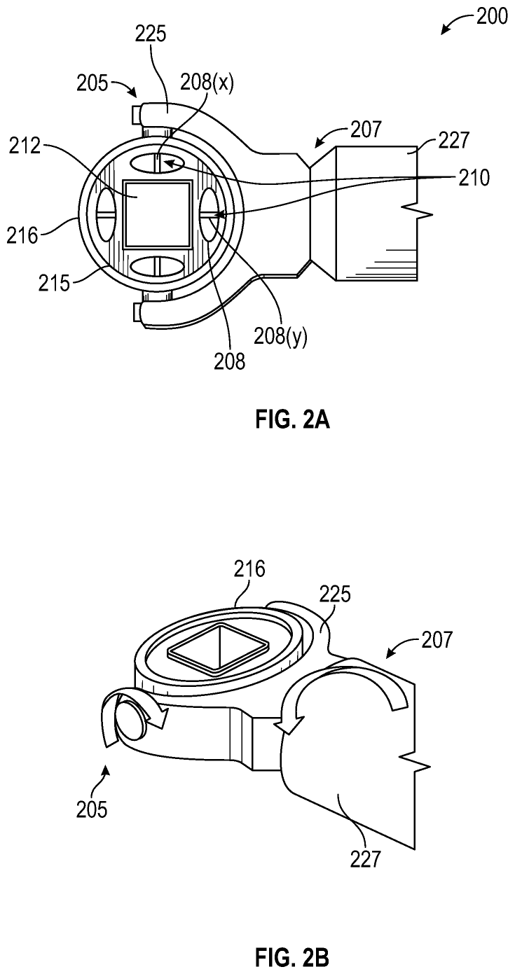

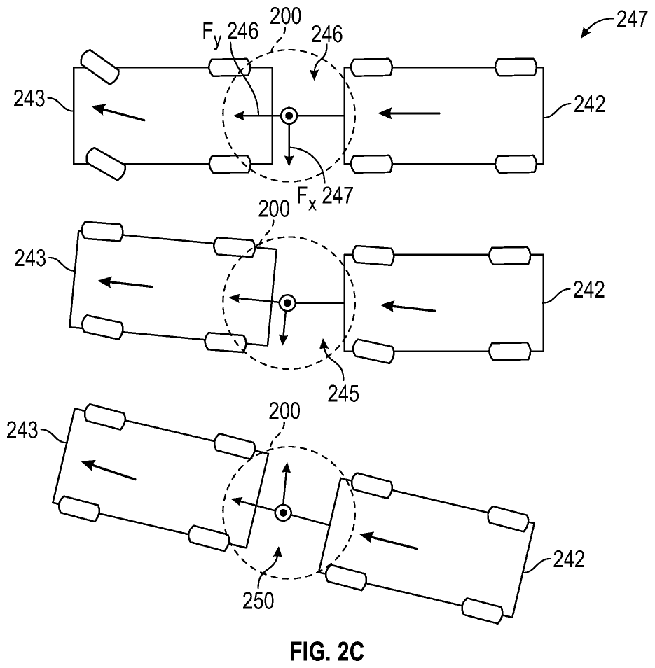

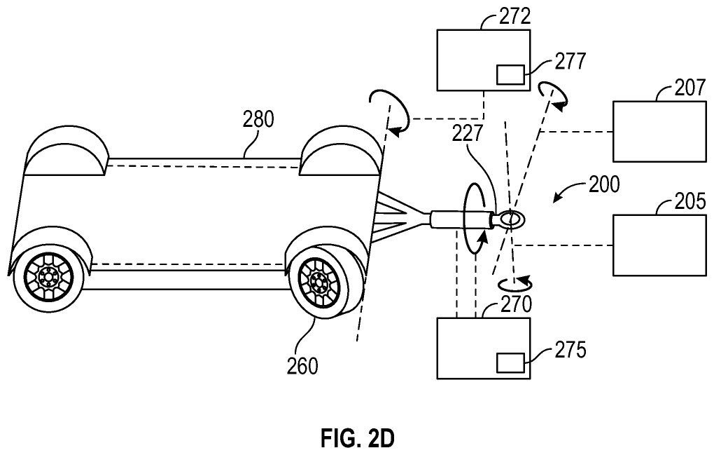

As depicted in FIG. 1, trailer 100 also includes the braking system 26 and the steering system 24 various embodiments. In exemplary embodiments, the braking system 26 controls braking of the trailer 100 using braking components that are controlled via inputs based on sensed data using calculated magnitudes and vectors of the trailer controller 34 and/or automatically via the (trailer) controller 34. Also in exemplary embodiments, the steering system 24 controls the steering of the trailer 100 via steering components that are controlled via inputs provided by sensed force and displacement of the sensing hitch 175 as well as automatically via the control system and intelligent sensing capabilities incorporated in the trailer 100. Also in various embodiments, the trailer controller 34 provides automatic braking via the braking system 26 as appropriate to mitigate trailer actions in conjunction with sensed data from the sensing hitch 175, the movement and operation of the vehicle 101 to which the trailer 100 is tethered, and actions during movement of the trailer 100 such as to mitigate sway movement for the trailer, in accordance with the steps of the implementation of FIG. 2 and the processes of FIGS. 3 and 4 and described further below.

In various embodiments, the sensor system 28 includes various sensors that obtain sensor data for controlling the sway of the trailer 100. In the depicted embodiment, the sensor system 28 can be configured to include a set of sensors including force sensors (e.g., force sensor integrated in the sensing hitch 175); trailer sensors (e.g., configured to measure a hitch articulation angle with respect to the vehicle 101, and/or in certain embodiments a weight of and/or other data pertaining to the trailer 100), speed sensors (e.g., wheel speed sensors and/or other sensors configured to measure a speed and/or velocity of the trailer and/or data used to calculate such speed and/or velocity), cameras (in certain embodiments, configured to capture images of the lane and roadway in which the trailer 100 is travelling, and in certain embodiments data pertaining to the trailer 100, such as a hitch angle at which the trailer 100 is attached to the vehicle 101 via the hitch apparatus), and acceleration sensors (e.g., an accelerometer and/or one or more other sensors for measuring and/or determining an acceleration of the trailer 100), and yaw sensors (for measuring and/or determining a yaw rate of the trailer 100). In various embodiments, various sensor data, including the hitch articulation angle and yaw rate, are used in monitoring and mitigating trailer sway for trailer 100.

In certain embodiments, the location system 130 is configured (the location system 130 may or may not be enabled when tethered to the vehicle 101) to obtain and/or generate data as to a position and/or location in which the trailer 100 is located and/or is traveling for transmitting to a third party monitoring the load conveyance, or to a driver system in the vehicle 101. In certain embodiments, the location system 130 includes and/or is coupled to a satellite-based network and/or system, such as a global positioning system (GPS) and/or other satellite-based systems. Also in certain embodiments, a display system (not shown) provides visual, audio, haptic, and/or other information for a driver of the lead vehicle 101 provided by the controller 34 via wired or wireless transmissions, pertaining to the trailer movement while tethered to the vehicle 101.

In various embodiments, controller 34 is coupled to the sensor system 28 as well as to braking system 26. In various embodiments, the controller 34 may also be coupled to one or more other trailer components, such as the steering system 24, the location system 130, a display, and/or other trailer components.

In various embodiments, the controller (or computer system) 34 controls trailer operation, including monitoring and mitigation of trailer sway for the trailer 100, steering angle of the trailer 100, and velocity/acceleration of the trailer 100 based on sensed forces to the sensing hitch 175 from the vehicle, and magnitude and displacement data generated by the sensing hitch 175. In various embodiments, controller 34 provides these and other functions in accordance with the steps of the processes of FIGS. 3 and 4.

In various embodiments, the trailer controller 34 (and, in certain embodiments, the control system itself) is disposed of within body 14 of the trailer 100. In one embodiment, the controller is mounted on chassis 12. In certain embodiments, the controller 34 (and/or control system) and/or one or more components thereof may be disposed outside the body 14, for example on a remote server, in the cloud, or other devices where processing is performed remotely.

It will be appreciated that while this exemplary embodiment is described in the context of a fully functioning computer system (of controller 34), those skilled in the art will recognize that the mechanisms of the present disclosure are capable of being distributed as a program product with one or more types of non-transitory computer-readable signal-bearing media used to store the program and the instructions thereof and carry out the distribution thereof, such as a non-transitory computer-readable medium bearing the program and containing computer instructions stored therein for causing a computer processor (such as the processor 44 of the controller 34) to perform and execute the program. Such a program product may take a variety of forms, and the present disclosure applies equally regardless of the particular type of computer-readable signal-bearing media used to carry out the distribution. Examples of signal-bearing media include recordable media such as floppy disks, hard drives, memory cards, and optical disks, and transmission media such as digital and analog communication links. It will be appreciated that cloud-based storage and/or other techniques may also be utilized in certain embodiments. It will similarly be appreciated that the computer system or processor 44 may also otherwise differ from the embodiment depicted in FIG. 1, for example in that the computer system or the controller 34 may be coupled to or may otherwise utilize one or more remote computer systems and/or other control systems.

As depicted in FIG. 1, in certain embodiments, the lead vehicle 101 can be configured as a conventional vehicle without autonomous features, a semiautonomous, or a fully autonomous vehicle. In each type of configuration, the force sensing hitch 175 operates similarly or the same to sense applied forces to the force-sensing hitch 175 that are caused by movement and actions of the vehicle 101 while tethered via the force sensing hitch 175 to the trailer 100. The force sensing hitch 175 does not differentiate as to the type of vehicle tethered, and only or is configured to generate sensed data based on forces applied to the sensing hitch 175 and the sensed data of related to direction and speed that are converted into commands by the trailer controller for the trailer 100 to perform driving actions while tethered to the lead vehicle 101 of steering, accelerating, braking to match the driving actions of the lead vehicle 101 in real-time, for a simultaneous or in concert operation of both the trailer 100 and vehicle 101 in operation.

In embodiments, the processor 44 receives data from sensors of the force-sensing hitch 175 that is time-stamped data by assignment of the processor 44 and the processor 44 is further instructed to compute at least two parameters that include magnitude and direction of the net force that is imposed upon the force sensing hitch 175. The processor 44 is configured with a clocking capability to time-stamp the data received, assign a time-stamped value to the data received from the force sensing hitch 175, and store a series of values over time for both the magnitude and direction of forces acting upon the force sensing hitch 175. Based upon the time-stamped data received from the force sensing hitch 175, the processor 44 is configured to calculate a) a rate-of-change of the force of magnitude and direction over time, as well as b) a cumulative integral over time of the force of magnitude and direction. This results in a set of at least six variables calculated and recorded by the processor over time, which include the following: an instantaneous force direction, an instantaneous force magnitude, a rate-of-change of force direction, a rate-of-change of force magnitude, an integral of force direction, and an integral of force magnitude. Based on the set of variables calculated, the processor 44 is further configured to calculate a trajectory for trailer 100 that will enable it to follow the trajectory of the lead vehicle 101 while providing its (the trailer 100) own motive force rather than depending upon a tractive effort from the lead vehicle. The trajectory calculated is implemented by an output from the processor 44 to a steering controller and a motor speed controller, which physically controls the motion of the trailer 100.

FIGS. 2A, 2B, 2C, and 2D illustrate various views of the hitch and connector assembly that couples the trailer to the vehicle of the hitch sensor system in accordance with various embodiments. In FIG. 2A, a diagram is illustrated of a top-down view of an exemplary electro-mechanical hitch assembly 200 (the “hitch assembly”) that couples the autonomous trailer to the vehicle is depicted. The hitch assembly 200 includes two or more sensors 210 that are configured with a load cell 208 that is positioned on the X and Y side of the square or on a rectangular shaped receiver 212 that holds the receiver 212 within the rigid frame 216. When a force is received in the X and/or Y directions, data is generated by either or both load cells 208(x) and 208(y) that measures the force exerted in either the X or Y directions to send to a vehicle controller (i.e., a processor) of a trailer configured to receive the load force data.

In embodiments, the sensors 210 located within the hitch assembly 200, monitor forces applied to the hitch assembly 200. In implementations, the sensors 210 can be configured into a first set of sensors that monitors forces imposed upon the hitch assembly 200 in the transverse direction, and a second set of sensors that monitor forces imposed on the hitch assembly 200 in the longitudinal direction. In this instance, forces applied to the hitch assembly 200 in the vertical direction are not monitored

In embodiments, the force data generated by the load cells 208 (ex. about joint 207) may be transmitted to controller 34 either wirelessly or via a cable connection. In embodiments, the load cells 208 can be configured in orthogonal sets of 2 and 4 around each side of the receiver 212. Also, a set of 3 load cells may be configured, for example, in a “Y” configuration, so as to indirectly measure force in the X direction, and Y direction.

In embodiments, the load cell 208 is a force sensing module to measure pull/push forces applied to the hitch 200 between the vehicle and the trailer operating together. The forces applied are used as a basis to control changes in velocity or acceleration of the trailer.

The hitch assembly 200 is also configured with a joint 205 that allows for clockwise and counterclockwise rotation about the transverse Y-axis of the frame 216, as well as rotation about the longitudinal X-axis of joint 207. The joint 205 is configured with a support frame 225 that is coupled via the joint 207 to an arm or beam 227 assembly that connects to the trailer. The joint 207 allows for X-axis rotation, the joint 205 allows for Y-axis and Z-axis rotation, and the two together constitute a gimbal joint.

In FIG. 2B, a diagram of a side view of the hitch 200 is illustrated that shows the rotation of the joint 207 that allows for rotation of the frame 216 about the X-axis or longitudinal axis to the support frame 225 and the rotation of the other joint, joint 205 about the Z or vertical axis, as well as the Y-axis or transverse axis. In embodiments, joint 205 allows rotation about the transverse Y-axis and the vertical Z-axis and joint 207 allows rotation about the longitudinal X-axis. The use of both rotational joints allows for mitigation or removal of torsional or bending loads applied to the arm or beam 227.

FIG. 2C illustrates a corrective action in response to force data received by the autonomous trailer from the hitch force sensing system in accordance with an embodiment. In FIG. 2C., in an initial scenario 240, the vehicle 243 and the trailer 242 are in line, and the hitch 200 is shown to be positioned in a straight type of configuration. As vehicle 243 moves to one side, a set of forces: Fx 246 and Fy 247 is applied to the hitch 200 in scenario 245 and received by trailer 242. In response, trailer 242 implements a change in steering direction and/or velocity to compensate for an aligned position as depicted in scenario 250.

FIG. 2D illustrates a diagram of trailer 280 with the independent steering control 260 on the front axle, an additional joint (third joint) 270 for rotating about a transverse axis, and a fourth joint 272 allowing for rotation about a transverse axis at the trailer body in response to forces applied to the hitch 200.

In an exemplary embodiment, the mechanism of the hitch can include the following: a first joint 207 which enables rotation about a transverse axis, located at the coupling where the hitch is affixed to the lead vehicle; a second joint 205 which enables rotation about a vertical axis, located at the coupling where the hitch is affixed to the lead vehicle; a third joint 275 which enables rotation about the longitudinal axis, located on the trailer beam 227 that extends rearward from the coupling (sensor 275 may be configured with the third joint 275 if required); and a fourth joint 272 allowing for rotation about a transverse axis, located at the connection between the rear of the trailer beam and the trailer body or chassis.

In embodiments, the trailer beam 227, spanning between hitch 200 and trailer 280 and connecting at joint 270, may be configured with one or more load cells (or positional encoders) 275 to determine fore/aft forces and displacement that may generate data that be used in calculations of velocity and steering angle. For example, load cells 275 may be used in load calculations of trailer loads and ancillary data for calculations in the velocity and accelerations of the trailer based on time.

In embodiments, the beam 227 may be configured in a hitch with a gimbal joint coupling at the joint 270 for attachment to trailer 280. While a certain hitch configuration type is depicted in FIG. 2D, it is contemplated that the disclosure is not so limited and that a multitude of different hitches may be implemented for connecting the autonomous trailer or semiautonomous trailer to the vehicle. Further, the hitches may allow or may not allow for weight distribution, and can include gooseneck hitches, receiver hitches, and various extenders with the load sensor incorporated. Additionally, a data connection between the lead vehicle and the trailer may optionally be included. For example, in an embodiment, data from the pin connector may be received by the trailer for control and also used in calculations of the velocity of steering angles. However, it is contemplated that the system is implemented without requiring any additional connector cables and therefore can be implemented with conventional hitches without data couplings.

The assembly of beam 227 and hitch 200 is configured for guiding trailer 280 and is a connected linkage that prevents uncoupling of trailer 280 from vehicle 243. The trailer 242 while operating in a self-propelled mode is always mechanically coupled to the vehicle. In an embodiment, during a towing operation, the vehicle 243 towing capacity is not relied upon by the trailer 242 as the trailer 242 is operating independently but for the guidance provided by vehicle 243. The vehicle 243 can therefore have a towing capability that is less than the towing capability normally required because the trailer 242 is operating independently and not relying on the vehicle 243 for propulsion. In embodiments, if the weight of the cargo supported by trailer 242 exceeds the trailer's propulsive capability, then in instances, the trailer 242 may be configured in operation to rely on the vehicle propulsion in part and also for guidance to the destination.

FIG. 3 illustrates a flowchart of steps of an exemplary algorithm implemented in the force-sensing hitch system in accordance with an embodiment. In FIG. 3, at step 305, the force sensing hitch system is initiated by the application of forces from the movement of the vehicle while mechanically coupled to the hitch of the trailer. The trailer may be configured in a standby mode, waiting for the detection of forces applied to the hitch to commence self-propelled operations. While it is contemplated the force sensing hitch is for use in self-propelled trailer operations, the hitch can also be mechanically configured to provide sufficient connection strength to allow for towing operation when a trailer is not operating in a self-propelled mode of operation. In this case, the hitch and hitch assembly would operate as a conventional linkage between the trailer and the vehicle.

At step 310, the data from the sensors is received (triggered by force input to the hitch) by a controller configured with a processor that can receive the sensed data from one or more of the load sensors and is used to calculate net force magnitude and direction at step 315, save force data with time-stamp at step 320, and at step 325 use the time series data to calculate a rate-of-change of a set of values, also using the time series data to calculate integral values at step 330. Then at step 335, saving the rate-of-change and integral values with time-stamps.

In embodiments, the steering angle is calculated at step 340 by looking at the force direction, rate-of-change of direction, and an integral of force direction. This calculation uses a PID algorithm, in which the wheels are turned to match the orientation of the net force vector, such that the difference between the steer angle and force direction is minimized. That is, the sensor data at enables the determining or reading of the force direction; the force direction is compared to the steering angle, and if the comparison results in a value that is not zero (or approximately zero or within a configured range), then accordingly, the steering angle is adjusted by a change to minimize the difference between the current force direction and the steering angle. For example, at step 350 the amount of change in the steering angle is dictated by the PID at step 340. This comparison step is repeated until the difference amount is reduced or nullified. That is, the force direction and steering angle is again re-compared (via a feedback loop) to re-compare the force direction to the steering angle, if it is not zero (or approximately zero within a certain range), the steering angle is again adjusted based on the PID at step 350.

The vehicle set speed is calculated by looking at the force magnitude, rate-of-change of the force magnitude, and an integral of the force magnitude. The calculation of the vehicle set speed uses a PID algorithm in which the vehicle set speed is adjusted to minimize the magnitude of the force at the hitch. In an embodiment, the start speed of the vehicle is set to equal zero (ex. start with set speed=0). If the magnitude of force is calculated not to be zero, then a change in speed is required by the trailer in response to the force applied to the hitch. The change in speed is increased in increments determined by the PID in step 345. After each incremental change in speed, the force is rechecked, and the speed is modulated by increments if needed in a feedback loop that is summed on the previous value until the magnitude of force measured at the hitch is determined to be zero (or approximately zero or within a configured range). Hence, at step 355, the error amount is calculated and the speed is changed by increments to decrease the error amount. The speed is set (i.e., increment plus previous value) at step 355. The wheel speed at step 360 is controlled in line with the incremental changes in a feedback loop. Hence, the incremental change in speed is what is being calculated and the actual set speed is determined by adding the incremental change to whatever the previous value was determined until the magnitude of force measured at the hitch is determined to be zero (or approximately zero or within a configured range).

It will be appreciated that the systems, vehicles, and methods may vary from those depicted in the Figures and described herein. For example, the trailer of FIG. 1, the control system, and/or components thereof of FIGS. 1-2 may vary in different embodiments. It will similarly be appreciated that the steps of the process may differ from those depicted in FIG. 3, and/or that various steps of the process may occur concurrently and/or in a different order than that depicted in FIGS. 1-2. It will similarly be appreciated that the various implementations of FIGS. 1-3 may also differ in various embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A method comprising:
generating, by a hitch in communication with a trailer, sensor data from one or more sensors that is responsive to one or more forces applied to the hitch wherein the one or more forces are provided by a lead vehicle mechanically coupled to the hitch;
receiving, by a controller disposed within the trailer the sensor data generated by the one or more sensors of the hitch to compute a direction for the guidance of the trailer wherein the trailer is configured as a self-propelled trailer;
monitoring, by the controller, a set of parameters reflecting one or more forces in a lateral and traverse direction derived from data generated by the one or more sensors of the hitch wherein the set of parameters comprise at least one parameter of a magnitude of force, and at least one parameter of the direction of force acting upon the hitch;
calculating, by the controller, a rate-of-change of the magnitude of force and direction over time, and a cumulative integral over time of the magnitude of force and direction of force applied to the hitch to determine a set of variables associated with an instantaneous force direction and magnitude, the rate-of-change of a force direction and magnitude, and an integral force direction and magnitude that are based on time-stamped data from the one or more sensors; and
calculating, by the controller, based on the set of variables that have been determined, a trajectory for the self-propelled trailer that enables the self-propelled trailer to follow the lead vehicle without depending upon a tractive effort of the lead vehicle.

2. The method of claim 1, further comprising:
outputting, by the controller, the trajectory that is calculated to a steering controller and a motor speed controller, which enables physical control of motion of the self-propelled trailer.

3. The method of claim 2, further comprising:
configuring the hitch to communicate with the controller to enable receipt of data from the one or more sensors so that the self-propelled trailer and the hitch can be guided manually or by the lead vehicle.

4. The method of claim 1, wherein the one or more sensors comprises a first set of sensors that monitor forces imposed upon the hitch in a transverse direction, and a second set of sensors that monitors forces imposed upon the hitch in a longitudinal direction.

5. The method of claim 1, wherein the hitch comprises a first joint enabling rotation about a transverse axis and located at the coupling about which the hitch is affixed to the lead vehicle, and a second joint enabling rotation about a vertical axis and located at the coupling about which the hitch is affixed to the lead vehicle.

6. The method of claim 5, wherein the hitch further comprises a third joint enabling rotation about a longitudinal axis and located on a trailer beam that extends rearward from the coupling, and a fourth joint enabling rotation about the transverse axis and located at a connection between a rear part of the trailer beam and a trailer body or chassis of the trailer.

7. The method of claim 2, further comprising:
adjusting, by the steering controller, a direction of a steering angle of a set of wheels of the trailer based on calculations from the force direction, rate-of-change of direction, and integral of force direction.

8. The method of claim 7, further comprising:
adjusting, by the motor speed controller, a set speed of the trailer based on calculations from the magnitude of the force, rate-of-change of force magnitude and integral of force magnitude so as to minimize at least one magnitude of force experienced at the hitch.

9. The method of claim 8, further comprising:
adjusting, by the motor speed controller, by an incremental change the set speed of the trailer based on a previous set speed value to minimize the magnitude of force experienced at the hitch.

10. A system comprising:
one or more sensors disposed in a hitch to provide sensor data onboard a trailer that is coupled to a lead vehicle; and
a processor configured to be coupled to the one or more sensors while onboard the trailer and configured to:
obtain sensor data from the one or more sensors configured within the hitch that is attached to the trailer;
receive the sensor data generated by the one or more sensors of the hitch to compute a direction for guidance of the trailer wherein the trailer is configured as a self-propelled trailer;
monitor a set of parameters that reflect one or more forces in a lateral and traverse direction derived from data generated by the one or more sensors of the hitch wherein the set of parameters comprise at least one parameter of a magnitude of force and at least one parameter of direction of force acting upon the hitch;
calculate a rate-of-change of a magnitude of force and direction of force over time, and a cumulative integral over time of the magnitude of force and direction of the magnitude of a force applied to the hitch to determine a set of variables associated with an instantaneous force direction and magnitude, a rate-of-change of a force direction and magnitude, and an integral force direction and magnitude that are based on time-stamped data from the one or more sensors; and
calculate, based on the set of variables that have been determined, a trajectory for the self-propelled trailer that enables the self-propelled trailer to follow the lead vehicle without depending upon a tractive effort of the lead vehicle.

11. The system of claim 10, wherein the processor is configured to:
output the trajectory that is calculated to enable physical control of motion of the self-propelled trailer.

12. The system of claim 11, wherein the processor is configured to:
receive the sensor data to compute directional data to guide the self-propelled trailer while coupled to the vehicle without necessitating the vehicle to provide motive force to the self-propelled trailer.

13. The system of claim 12, wherein the processor is configured to:
configure the hitch to enable receipt of data from the one or more sensors so that the self-propelled trailer and the hitch can be guided manually or by the lead vehicle.

14. The system of claim 10, wherein the hitch comprises a first joint enabling rotation about a transverse axis and located at the coupling about which the hitch is affixed to the lead vehicle, and a second joint enabling rotation about a vertical axis and located at the coupling about which the hitch is affixed to the lead vehicle.

15. The system of claim 14, wherein the hitch further comprises a third joint enabling rotation about a longitudinal axis and located on a trailer beam that extends rearward from the coupling, and a fourth joint enabling rotation about the transverse axis and located at a connection between a rear part of the trailer beam and a trailer body or chassis of the trailer.

16. The system of claim 15, wherein the processor is configured to:
adjust a direction of a steering angle of a set of wheels of the trailer based on calculations from the force direction, rate-of-change of direction, and integral of force direction.

17. The system of claim 16, wherein the processor is configured to:
adjust a set speed of the trailer based on calculations from the magnitude of force, rate of change of force magnitude, and integral of force magnitude so as to minimize magnitude of force experienced at the hitch.

18. The system of claim 17, wherein the processor is configured to:
adjust by an incremental change the set speed of the trailer based on a previous set speed value to minimize the at least one magnitude of force experienced at the hitch.

19. An apparatus comprising:
a hitch comprising a mechanical coupling between a trailer and a vehicle; and
a communication connection to enable sending of sensor data provided by the hitch to a processor device remote from the hitch;
wherein the hitch is configured with one or more sensors that generate the sensor data sent to the processor device wherein the sensor data is generated in response to one or more forces applied by the vehicle via the mechanical coupling of the hitch;
wherein the processor device is disposed remotely in the trailer and enables control of a trajectory of the trailer while operating via the communication connection to the vehicle wherein the processor device is configured to:
obtain the sensor data from the one or more sensors configured within the hitch that is attached to the trailer;
receive the sensor data generated by the one or more sensors of the hitch to compute a direction for guidance of the trailer wherein the trailer is configured as a self-propelled trailer;
monitor a set of parameters that reflect one or more forces in a lateral and traverse direction derived from data generated by the one or more sensors of the hitch wherein the set of parameters comprise at least one parameter of a magnitude of the force and at least one parameter of direction of force acting upon the hitch;
calculate a rate-of-change of a magnitude of force and direction over time, and a cumulative integral over time of the magnitude of force and direction of the magnitude of a force applied to the hitch to determine a set of variables associated with an instantaneous force direction and magnitude, the rate-of-change of a force direction and magnitude, and an integral force direction and magnitude that are based on time-stamped data from the one or more sensors; and
calculate, based on the set of variables that have been determined, the trajectory for the self-propelled trailer that enables the self-propelled trailer to follow the vehicle without depending upon a tractive effort of the vehicle.

20. The apparatus of claim 19, wherein the mechanical coupling is configured with a set of joints that allow for motion about a transverse Y-axis, a longitudinal X-axis, and a Z-axis of a frame of the mechanical coupling and is responsive to the one or more forces applied by the vehicle.
